(19) United States
(12) Patent Application Publication
(10) Pub. No.: US 2005/0096982 A1
(43) Pub. Date: May 5, 2005

(54) Method of viral marketing for email and internet based advertising

(76) Inventors: David L. Morton, Sandy, UT (US); Corey A. Young, South Jordan, UT (US); William James Marsden, South Jordan, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 10/942,315

(22) Filed: Sep. 15, 2004

Related U.S. Application Data
(60) Provisional application No. 60/562,165, filed on Apr. 13, 2004.
(60) Provisional application No. 60/503,515, filed on Sep. 16, 2003.

(51) Int. Cl. G06F 17/60

(52) U.S. Cl. 705/14

(57) ABSTRACT

A method of marketing includes encouraging existing customers to send messages to persons known to them endorsing products they have used and encouraging the other persons to use the products. In particular, the customer's database of contacts is used to generate the message.

### RELATED APPLICATIONS

The following U.S. Non-Provisional patent application claims the benefit of U.S. Provisional Application No. 60/562,165, filed on Apr. 13, 2004, and U.S. Provisional Application No. 60/503,515, filed on Sep. 16, 2003.

### BACKGROUND OF THE INVENTION

1. The Field of the Invention

The present invention relates to methods for marketing goods or services to potential customers. More specifically, it relates to a referral method of advertising which is particularly suited to the use of email and the internet to generate a list of contacts and automatically send an advertisement to the contacts.

2. State of the Art

Marketing involves introducing potential costumers to goods and services. The type of marketing that is best suited for a particular situation depends on the goods or services offered, the type of potential customer, and the amount of money allocated to the marketing strategy.

One element of marketing particularly suited to nearly all types of goods and services is endorsement. Advertising strategies typically utilize athletes, actors, models, celebrities, experts in the product area, etc. to endorse the good or services offered and promote its sale. Endorsements of a product increase the consumer's confidence in the good or service offered and make the consumer more likely to purchase the good or service.

One particularly effective type of endorsement is a personal endorsement, or word-of-mouth endorsement. A word-of-mouth endorsement might be viewed as where a person known or trusted by a consumer endorses a good or service by commenting on the good or service or encouraging the consumer to purchase the good or service. These types of endorsements are particularly effective because the consumer already has an established relationship with the person endorsing the good or service and is likely to place confidence in their opinion.

While word-of-mouth advertising and endorsement of goods or services is one of the most effective types of advertising, it can be difficult to implement and is not widely used. A common limitation of word-of-mouth advertising is that it is difficult to encourage most consumers to advertise goods or services to others. One factor in why most consumers are unlikely to endorse goods or services to others is the time and effort required to do so. Even if pleased with a good or service, most consumers will not likely mention or endorse the good or service to another unless the good or service comes up in a conversation or they are asked specifically about the good or service. Most consumers are sufficiently busy with the daily occurrences of their lives that they are unwilling to spend an appreciable amount of time advertising products to their friends and acquaintances.

It is thus desirable to have an effective method for marketing goods or services through word-of-mouth endorsements. It is also desirable for such method to require minimal effort by the consumer endorsing the good or service by automatically performing many functions of the advertisement such as: generating a contact list, preparing an endorsement of the good or service, providing an incentive to the consumers endorsing and purchasing the good or service, and tracking the results of the marketing strategy.

### SUMMARY OF THE INVENTION

The present invention provides a solution to many of the problems in encouraging consumer to consumer word-of-mouth advertising by providing a system which is easy to use, performs many of the advertising functions automatically, requires little time to use, and provides a reward or incentive for both the consumer endorsing the product and the consumer who may purchase the product.

According to one aspect of the present invention, the internet is used to send advertising which endorses a good or service to persons known to a consumer who has purchased the good or service. A consumer who has purchased a product may log onto the manufacturers website and provide the identification of persons with whom they are acquainted and who will receive an endorsement of the product. The consumer may be enticed to do so by an offer of a rebate, upgrade, savings on other products, opportunities to win free merchandise, etc. The endorsement of the product may then be automatically generated and sent to the persons identified by the consumer.

According to another aspect of the present invention, email may be used to request endorsement of the desired good or service from a consumer who has acquired the good or service. When a consumer purchases a product, an email may be sent to the consumer thanking him or her for their interest in the product and requesting that they send an endorsement of the product to others. The email may contain an incentive for the consumer to send endorsements, such as a free product, rebate, upgrade, or opportunity to win another product. The email may also contain a hypertext link which, when used, could begin the process of sending endorsements to other potential customers.

According to another aspect of the present invention, the generation of a contact list of persons known to the consumer who will receive an endorsement of the product may be automatic. When a person purchases a product, an email may be sent with a hypertext link which causes a program to automatically generate a contact list. The program may scan through the consumer's email address book and select the contacts contained therein to receive an endorsement of the product. The consumer may then edit the list, unselecting any individuals therein who the consumer does not want to send an endorsement. Opportunity may be given the consumer to add contacts that are not found in his or her email list, and may provide for adding contacts who do not have an email address. Similarly, if a product is purchased or downloaded online, a similar hypertext link may exist which starts the same program for automatic generation of a contact list.

According to an aspect of the invention, the endorsement of the product may be generated automatically and sent automatically to the contacts indicated by the consumer. The product vendor may have a pre-prepared endorsement of the product which automatically inserts the name of an individual and is automatically sent to the individual. This automatic sending may be done for all persons on the contact list generated by the consumer. The endorsement may be sent by email to the contacts, or may be sent by conventional mail to contacts who do not have an email address.

According to another aspect of the invention, an incentive may be given to the contacts indicated by the consumer to encourage them to purchase the product. The contacts may receive a special offer or discount, a free trial version of the product, etc. as will be best suited to the individual good or service. The endorsement may contain a special promotional code or hypertext link to allow the person to access the special offer.

In accordance with yet another aspect of the invention, the generation of the email or other communication need not be limited to a purchase situation. For example, the website for a nonprofit organization could have the option present to forward an alert regarding a pending piece of legislation or an upcoming fund raiser to those who may not normally visit the site. A person visiting and site and deciding to inform friends, relatives, etc., need only click on the appropriate link. The program may then access the email or other addresses and the person could unselect those to whom he or she did not want the forward the message. Within a matter of minutes, and with virtually no effort on the part of the person visiting the site, numerous people are notified of the invention of “advertising” on the organization's website.

In accordance with still another aspect of the invention, the endorsement of customers can be used to rapidly build networks of people. For example, there has been tremendous growth in the use of instant messaging. When a user subscribes to an instant messaging service, the user is provided the opportunity to send a message to friends who may also wish to join the same service. Few customers, however, will take the time to manually type in the name and email address of numerous friends. In accordance with the present invention, the address book of the user is accessed and enables them to send messages to a large number of contacts with only a few clicks of the mouse. Likewise, a similar arrangement can be used to expand cellular an digital telephone networks that provide free or discounted calling between members of the network. As people begin to receive a number of endorsements from their friends for a particular network, they are more likely to switch service or add an additional telephone with which they can received rates for telephone calls.

### BRIEF DESCRIPTION OF THE DRAWINGS

Various aspects of the present invention are shown and described in reference to the drawings. It will be appreciated that the embodiments of the invention are illustrative, but not limiting of the scope of the invention. The invention will be discussed in reference to numbered drawings wherein:

FIG. 1 is a diagram which describes how email might be used to endorse a product;

FIG. 2 is a diagram showing how the internet may be used to endorse a product which is purchased or downloaded online;

FIG. 3 shows a message thanking a customer for his or her purchase and requesting referrals who will be sent advertising endorsements of the product;

FIG. 4 shows an example massage that might be sent to the referrals identified by the customer;

FIG. 5 shows an example contact list which may be generated automatically;

FIG. 6 shows a message thanking the customer for their efforts in endorsing the product.;

FIG. 7 shows diagram of how endorsements or references may be used in connection with information found online;

FIG. 8 shows a diagram of a method of endorsing an online service to build a network of people using a common service;

FIG. 9 shows a diagram of a method of endorsing a company or product through existing customers to build a larger customer group;

FIG. 10 shows a flow chart describing the communication of referral servers to a user's computer;

FIG. 11 shows a flow chart detailing the process of obtaining contact information from a user;

FIG. 12 shows a flow chart which describes the process of obtaining a referral from a user;

FIG. 13 shows a flow chart how a referral server determines whether contact information may be acquired automatically or manually;

FIG. 14 shows a flow chart which details some aspect of manually entering contact information; and

FIG. 15 shows a flow chart detailing how referrals are sent to the referral server.

### DETAILED DESCRIPTION

The drawings will now be discussed in reference to numerals provided. It is understood that the drawings and description thereof are for explanatory purposes and are not intended to narrow the scope of the appended claims.

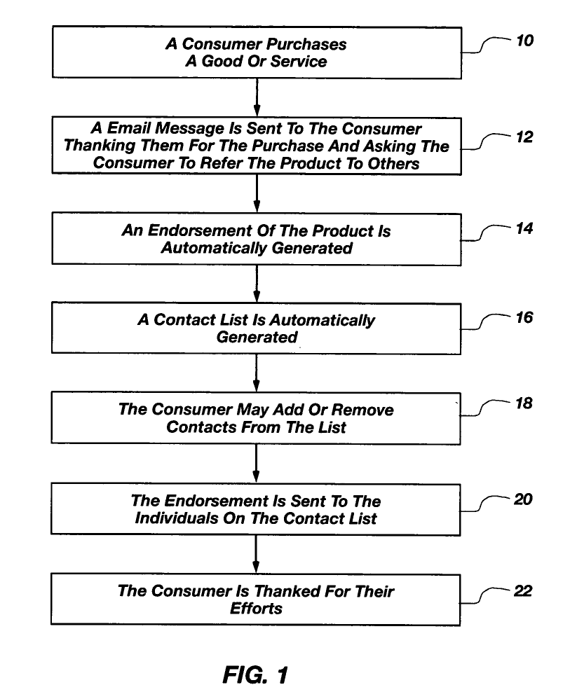

Referring now to FIG. 1, a diagram is shown which demonstrates an example method of advertising according to the present invention. The advertising process may begin when a consumer purchases a product from a company 10. Alternatively, the method of advertising can be performed by contacting prior customers as a follow-up to previous sales. The customer is then contacted by the company 12. Email is especially suited to this method of advertising for contact with customers and potential customers, as will be discussed. The first communication with the prior customer 12 may thank them for their purchase or use of the product. The message 12 may also provide a method of sending feedback to the company about the product. The message 12 also may ask the customer to refer the product to others. This message 12 may typically contain an incentive to the customer to refer the product to others, such as a free product, a free upgrade, a discounted product or upgrade, or an entry into a drawing to win a free product. The message 12 may also contain an incentive to the persons referred to the product by the customer, such as a special discount or free trial period. Email is especially suited for the message 12 to the customer because a hypertext link may be provided whereby an endorsement 14 of the product is automatically generated when the customer clicks on the link.

The endorsement 14, which may thus be automatically generated, may contain a brief description of the product, express the customer's satisfaction with the product, or recommend that the person use the product. The endorsement 14 may also outline an incentive for the person to use the product, such as a free trial period, a special purchase price, or free upgrades fro the product. If the endorsement 14 contains such incentives, it will typically have a promotional code or hypertext link allowing the person to take advantage of the offer. The promotional code or link may also be used to track the person's referred to the product by the customer and may provide additional rewards to the customer for each person referred by the customer who purchases the product.

The endorsement 14 generated, if done through email, may also contain a link to generate a contact list 16. When the customer activates this link, a program can automatically generate a list 16 of persons known by the customer by collecting such data from a location such as the customer's email address book, common contact lists, or databases available on the customer's computer. The contact list 16 may be generated in a table or spreadsheet format and allow the customer to delete persons 18 from the list 16 that the customer does not believe will be interested in the product, and add persons 18 who he or she thinks will be interested in the product. Although email is the preferred method for sending endorsements 14 of a product, the contact list 16 may also allow the customer to add the names and addresses of persons without an email address 18 and an endorsement 14 of the product may be sent to their residence.

Upon approval of the contact list 16, a link may be provided whereby the product endorsement 14 is sent 20 to the persons on the list. This may be accomplished through a hypertext link if performed via email. If email is used for the advertisement, email containing the endorsement 14 may be sent automatically 20 to the persons on the contact list 16.

Typically, the customer is thanked 22 for their efforts in referring the product. A web page thanking the customer may be opened automatically after the endorsements 14 are sent to the persons on the customer's contact list 16. The thank you page 22 may contain a confirmation of any special benefit or offer to the customer provided as an incentive to endorse the product to persons known to him or her. A thank you message 22 may also be sent to the customer's residence by regular mail.

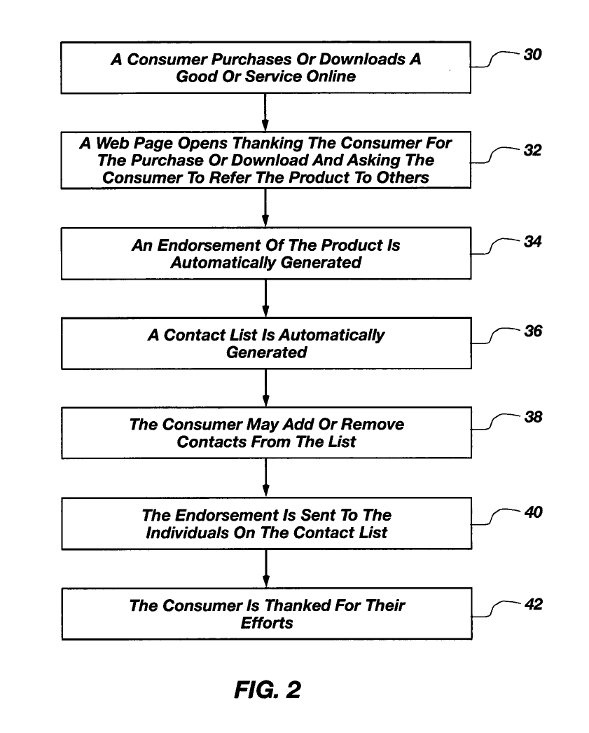

Referring now to FIG. 2, a diagram is shown outlining how the process would work when utilizing online advertising or downloading a product from the internet 30. The advertising would typically begin when the customer purchases or downloads the product 30. After the purchase or download 30 a new web page could open thanking the customer for their interest in the product 32. This page 32 could then ask the customer to refer the product to other persons the customer thinks would be interested in the product. The page 32 may also outline an incentive for the customer to refer others to the product, such as a free upgrade or related product, a discount on other products, or entry into a drawing to win a free product. The page 32 may also describe an incentive for the persons referred to the product to purchase the product, such as a discount, free upgrade, or free trial period.

The web page asking for referrals 32 could have a hypertext link for the customer to use which could then automatically generate an endorsement 34 of the product. Similar to the method outlined in connection with FIG. 1, the endorsement 34 could describe the benefits of the product and provide an incentive for the person referred to the product to purchase the product. Upon approval of the endorsement 34, the customer could be prompted to use another hypertext link which could automatically generate a contact list 36 of persons in the customer's email address book. The contact list could also be generated by scanning common databases or contact list found on a customer's computer. The customer could then add persons to the list or remove persons from the list 38. When finished with the list 36, a link may be provided to the customer which automatically sends 40 the endorsement 34 to the persons on the customer's contact list 36. Typically, the customer could then be thanked for their efforts to endorse the product 42. The customer could also be provided with confirmation of any incentive used to encourage the customer to refer the product to others.

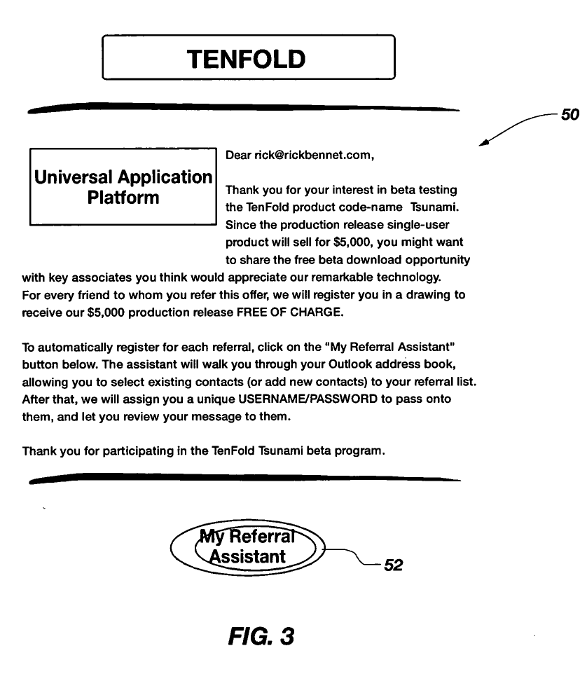

Turning now to FIG. 3, an example message is indicated generally at 50 which asks a customer to refer a product to other persons. This example message 50 is generated electronically, either by email or through a web page following download of the product. The message 50 thanks the customer for their interest in the product, asks the customer to refer the product to others, and provides an incentive for the customer to refer the product and for others to use the product. The customer is provided with an entry into a drawing to win a free release version of the product. The persons referred to the product are given an opportunity to download the product and use it for free during a test period. The message 50 also describes how the product endorsement and referral list will be generated automatically when the customer uses a “My Referral Assistant” link 52 provided in the message. At the bottom of the message 50 is included a “My Referral Assistant” hypertext link 52 which will automatically generate a product endorsement 60 and a contact list 70 when the link is used by the customer.

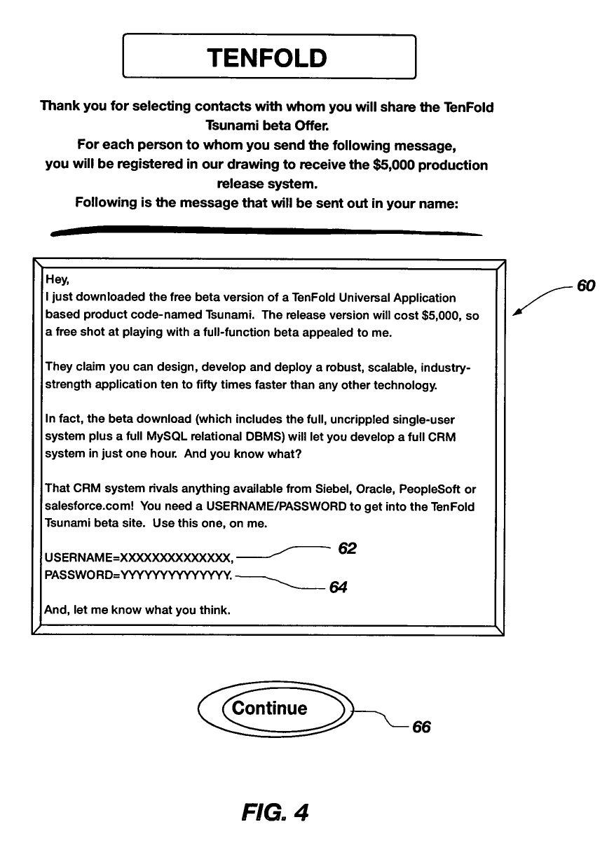

Referring now to FIG. 4, an example product endorsement is indicated generally at 60 which could be generated automatically when the customer uses the “My Referral Assistant” link 52 shown in FIG. 3. The endorsement 60 describes the advantages of the product and gives the person an incentive to use the product, in this case a free trial period. The endorsement 60 also contains a username 62 and password 64 which will allow the person referred to the product to download the product. The username 62 and password 64 may also be used to track which of the customer's referrals use the product and may be used to provide further benefits to the customer. The endorsement message 60 contains a “Continue” link 66 which, when used by the customer, may automatically generate a contact list 70 of persons to send to endorsement 60 to.

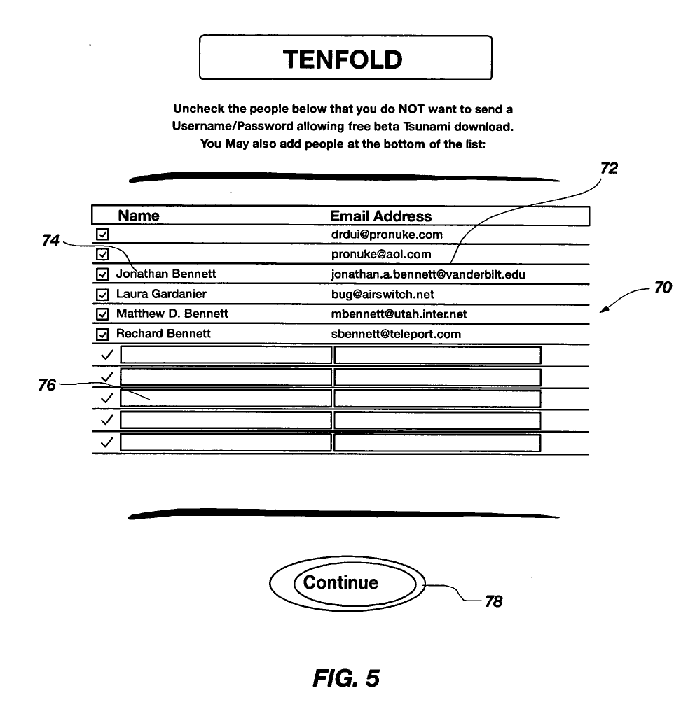

Turning now to FIG. 5, an example contact list is indicated generally at 70 which may be automatically generated when a customer uses the “Continue” link 66 described in reference to FIG. 4. The contact list 70 may be generated by automatically using the contact information 72 contained in the customer's email address book. The customer may then remove persons 74 from the contact list 70, and may also add persons 74 to the contact list using spaces 76 provided in the contact list 70. A “Continue” link 78 is provided on the web page containing the contact list 70. When the customer uses the continue link 78, the endorsement message 60 will automatically be sent to the persons on the contact list 70.

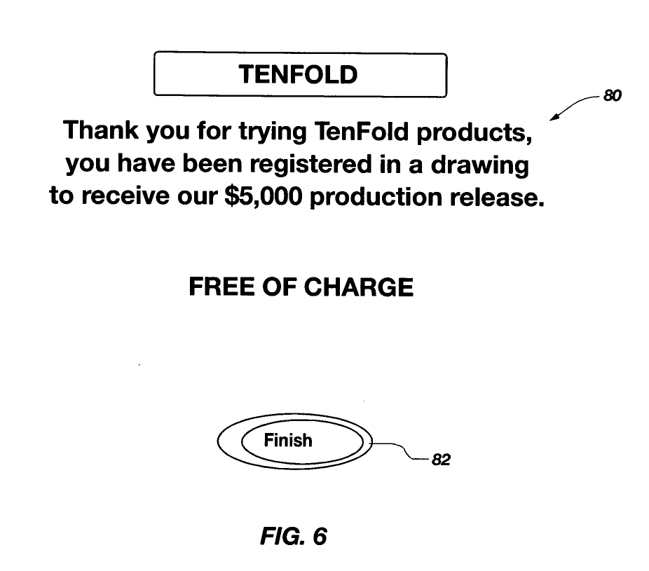

Turning now to FIG. 6, an example message is indicated generally at 80 thanking the customer for referring the product to others. A confirmation of the incentive offered the customer for referring the product to others may be included in the thank you message 80. A “Finish” link 82 is shown which may end the referral process or close the web page when pressed by the customer.

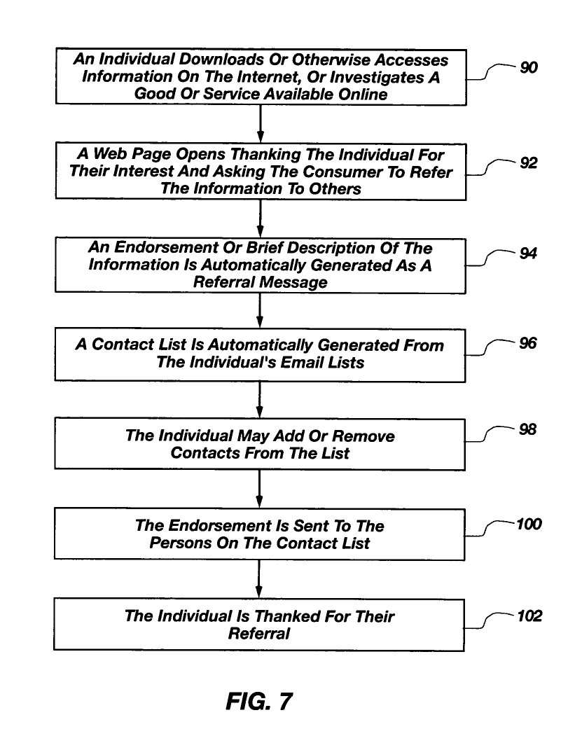

Referring now to FIG. 7, a diagram is shown indicating how the method of advertising could be used in connection with distributing information or attracting consumers to a website. The process may begin where an individual accesses a website, or accesses or downloads information on the internet, or investigates a good or service on the internet 90. The website which the individual is viewing could be configured such that when the individual begins viewing a document, closes a document that he or she was viewing, or exits the website a window could open asking the individual if he or she would like to share the information with a friend 92. This referral web page may be configured to have a “No Thanks” button which closes the window, and a “Yes” button which continues with the referral process.

If the customer clicks on the “Yes” button, a new web page may loaded which displays an endorsement or brief summary of the information or website 94 which will be sent as the referral message. This referral message may be shown to the individual so that he or she may see the referral which will be sent to their friends. The referral may typically include a message such as “I found this today and thought you would be interested in it” or “I thought this website was great and thought you would like it,” along with a description of the website or information. The referral message may also be designed to have a hypertext link which a person could click and directly bring up the website or information which they were referred to. The endorsement message page will have a “continue” button which the individual may click to continue with the referral. Typically, the continue button will bring up a contact list page 96.

The contact list may be automatically generated from the individual's email addresses or similar address books, or from databases on the individual's computer. The advertising software may be programmed to automatically find contact names from email address books and other common contact lists and generate a contact list from this information.

Once a contact list is generated, the individual will typically have the option to add or remove names from the contact list 98. The individual will typically then click on a “continue” button which will be located on the contact list page. Clicking on the “continue” button sends the referral message to the individuals on the contact list 100. After the referral is sent, the individual is thanked for referring the website or information to their friends 102.

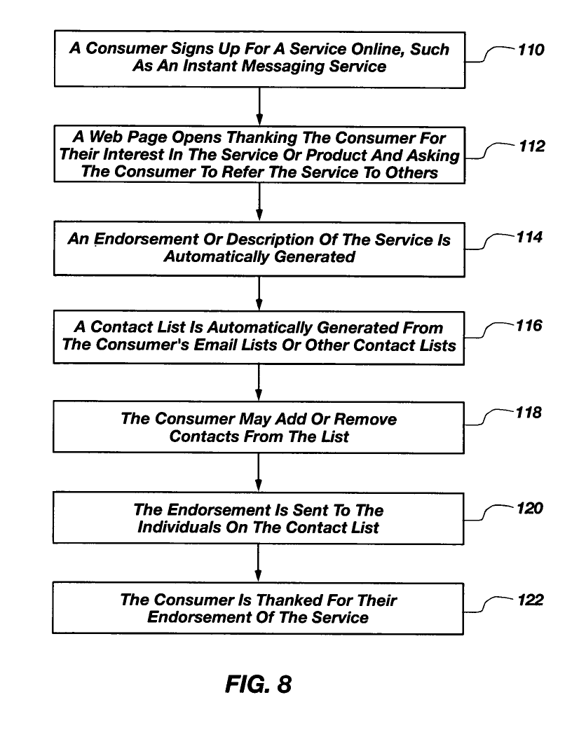

Referring now to FIG. 8, a diagram is show illustrating how the advertising method might work in connection with online services, such as an instant messaging service 110. Many such services are available online. Commonly, a person will be searching for a particular service such as instant messaging, a photo sharing service, etc. One major concern when choosing one of these services is whether or not a person will be able to reach his or her friends through the service. This can become a powerful advertising incentive to attract users to an online service by alerting potential users that upon signing up for a service they will be able to easily alert their friends to the service and their friends will be able to quickly sign up for the same service. This can be done on the web pages describing the service to potential service users who are investigating a particular service.

When a person signs up for an online service, a web page may open thanking them for their interest in the service and asking them to refer the service to their friends 112. There will typically be hypertext link buttons on this web page allowing the individual to refer the service to friends or to decline referring the service. These buttons will typically be displayed in connection with an invitation to refer the service to friends, and display messages such as “no thanks” and “yes.” If the person clicks on the “no thanks” button, the web page will typically close. If the person clicks on the “yes” button, the web page will load a new page which contains an endorsement of the service 114. The endorsement will typically contain a phrase such as “I just joined this instant messaging service (or whatever type of service is involved) and want you to join so we can chat easily,” as well as a description of the service. The endorsement will also typically contain a hypertext link which allows the recipient of the endorsement to click the link to learn more about the service and sign up for the service. Upon receiving the endorsement and clicking on the link, the recipient will typically be taken to a portion of the service provider's website which describes the service and allows the person to sign up for the service.

The example endorsement which is displayed to the individual signing up for the service and referring friends will typically have a “continue” button at the bottom which, when pressed, leads to a contact list page 116. The contact list page may be automatically generated by the website. The website would typically scan the individual's email address books, instant messaging lists, common contact lists, or computer databases and retrieve names and email addresses and compile these into a chart of contacts. Automatically generating the contact list simplifies the referral process for the individual and makes the individual more likely to include more people on the list, and less likely to quit the referral process because they are daunted by the task of generating the contact list themselves or do not want to take the time to do so. The contact list will typically allow the individual to add or delete contacts from the list 118. The individual will then press a “continue” or “send endorsement” button which will send the endorsement message to the persons on the contact list 120. The individual is then typically thanked for their efforts to refer the service to their friends 122.

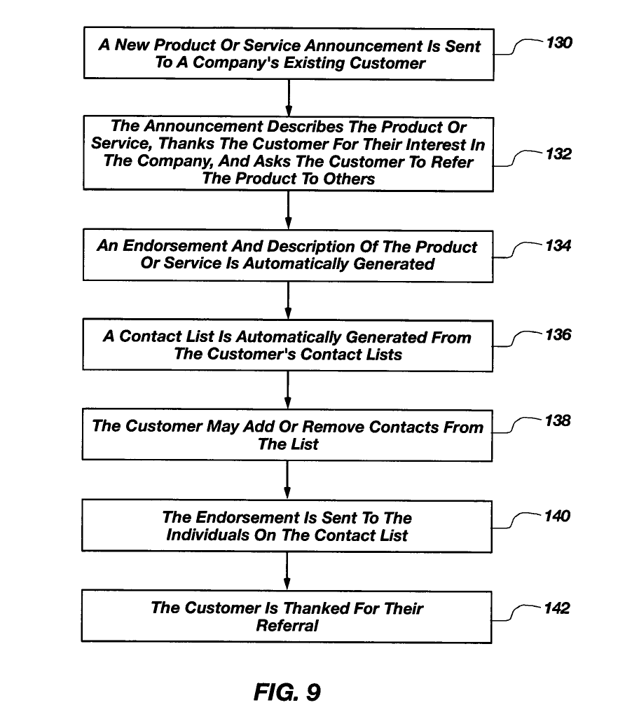

Turning now to FIG. 9, a diagram is shown which illustrates how the advertising method may be used to in connection with advertising sent by a company to existing customers. The process typically begins when a company sends a promotional offer or announcement about a new product or service to an existing customer 130. The announcement would typically have a description of the product or services, or a special offer 132. The announcement would also ask the customer to refer the company, advertisement, or offer to friends who would be interested 132. The announcement would have a “send referral” or similar hypertext button which the customer would click to send a referral to friends.

When the referral button is clicked, an endorsement is automatically generated and loaded into a new internet window 134. The endorsement would typically contain the special offer, description of goods or services, or description of the company, as well as a phrase such as “I use this company's products and thought you would like them too.” The endorsement message window would also have a “continue” or “generate contact list” hypertext link button which, when pressed, would automatically generate a contact list 136. The web page would typically be programmed to browse through the customer's email address lists, databases, or other common contact lists and form a table of contacts. The customer would then be able to add contacts or delete contacts from the list 138. The customer would then click on a “send endorsement” or “send referral” button which sends the endorsement to the persons on the contact list 140. The customer is then typically thanked for their referral 142.

It will be appreciated that one aspect of the invention is the ability to scan through email contact lists or address books, or contact lists in general to automatically generate a contact list for spreading referrals or advertising. The method may be initiated in many ways, such as an individual purchasing a good or service, signing up for a service, reading information online, visiting a website, etc. Contact between the individual and a host website or company is generally initiated by the individual, although it is equally possible and contemplated that a host website may contact an individual with whom the host has not had previous contact and initiate the advertising method.

After contact between the individual and the host website, the host will extend an offer to the individual to refer the host's services or products to others known by the individual. The offer may include an incentive for the individual to refer the host to others known by the individual. The host may automatically generate an endorsement or referral of the product or service to be sent to the individual's friends. The host can then automatically, through a computer program running on the host website, scan the individual's email address books, databases, and other common contact lists and generate a contact list of persons to whom the endorsement will be sent. The individual can typically then modify the contact list, adding or deleting contacts as desired, and then can send the endorsement to those individuals.

It is advantageous to automatically generate a contact list by scanning through an individual's email address book and other common contact lists. Individuals are more likely to complete the endorsement or referral if they are not required to manually enter all of the contact information themselves. Additionally, individuals are more likely to include more people on their contact list when they have the option of deleting contacts than where they are required to add every contact to the list individually.

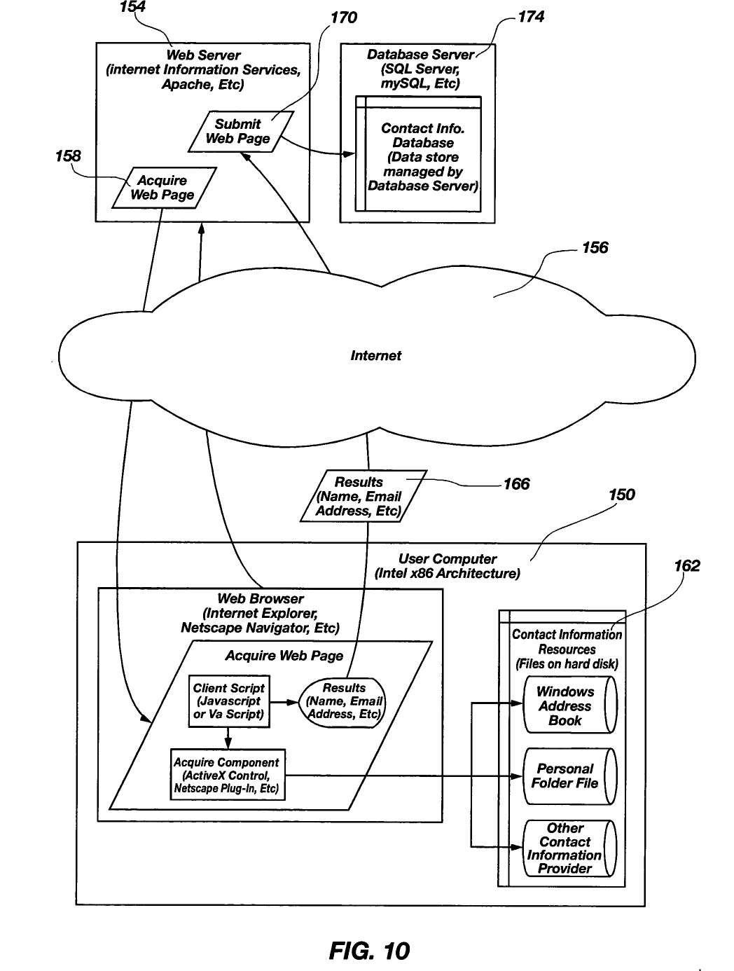

Referring now to FIG. 10 through FIG. 17, flow charts are shown which give a further example of how the present invention may be implemented.

Turning to FIG. 10, it is shown that a user computer 150 may access or receive communication from a web server 154. This may be accomplished where a user receives an email from the web server, or in situations where a user is browsing through web sites and is connected to the web server through a link, etc. The communication will typically occur through the internet 156. Fundamental to the communication, the user is prompted to send a referral regarding a product or service to friends. To facilitate the referral, the web server may open an acquire web page 158 which harvests contact information from the contact information resources 162 which may be located on a user's computer, including address books, personal folder files, or contact information maintained by various programs.

The acquire web page collects the contact information and presents it to the user as the results 166, and allows the user to submit the results and thereby send the referral via a submit web page 170. The web server may maintain and process the information, or may function in conjunction with a database server 174. The referrals generated will typically be sent as emails to the individuals referred by a user.

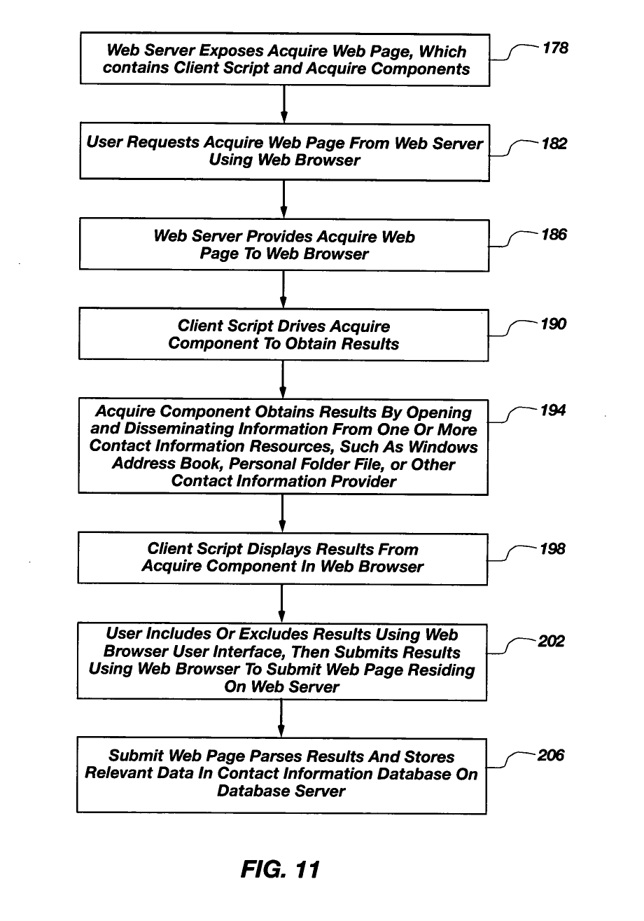

Turning now to FIG. 11, a flow chart is presented with greater detail regarding the acquisition process. Initially, the acquire web page is presented to a user 178, possibly as a link to begin the referral process. This may occur after the user receives a promotional email and clicks on a referral link. Next, the user would click on the link presented, or otherwise activate the acquire web page 182. The acquire web server then will typically open the acquisition/referral web page 186. A script or other program will then typically obtain referral information from the user's computer 190, typically by scanning address books, etc. as shown in 194.

Once the referral information is gathered, it is typically presented to the user 198. The user may then include additional contacts or exclude some contacts as desired 202. Once the user is finished, the information is sent to the web server for processing and storage.

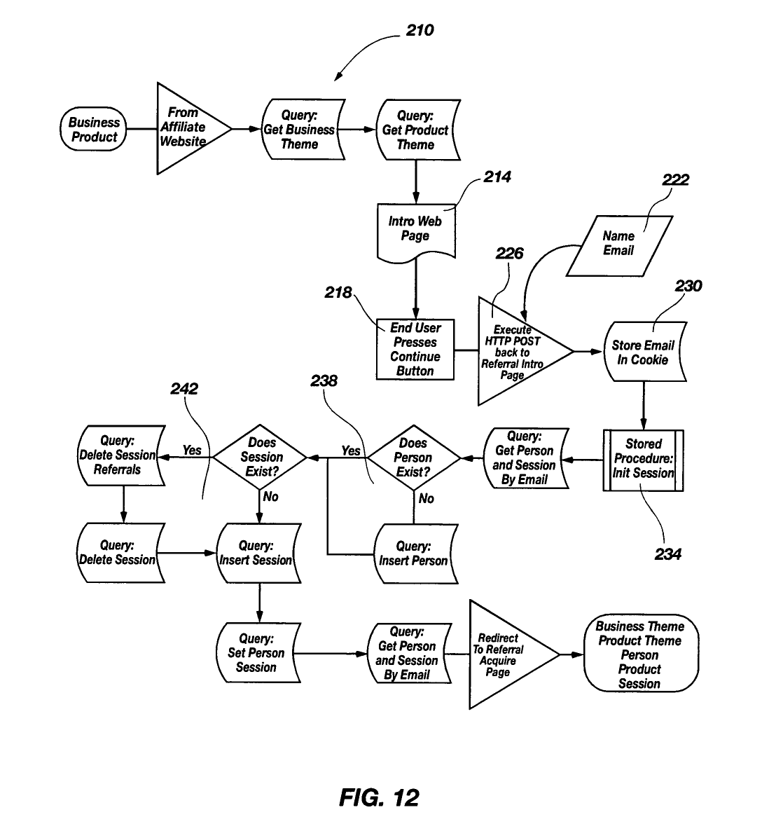

Turning now to FIG. 12, a flow chart is shown which details various steps taken in completing a referral process. Initially, it is necessary to retrieve information about a product or service which will be advertised via referrals. These steps are indicated generally at 210, and include gathering information regarding the business, product or service, and the themes of the referral. This information is collected and presented as a referral invitation, indicated as the intro web page 214. This referral may be initially presented as a web page to individuals browsing the product, or sent as an email to individuals with known interest in the product.

Once a user receives the initial referral invitation, they may decide to send the referral to others, and would typically click on a continue button 218. The referral program then gathers contact information 222 from then user and collects this information back into the referral page 226, and stores the information 230.

Sessions may be used to manage the collection of information, whereby a single browsing session may be used to track the users inputs in entering referral information, and to track the collection of referral information 234. During the session, logic loops are used to verify contact information 238 and to manage the referral gathering session 242.

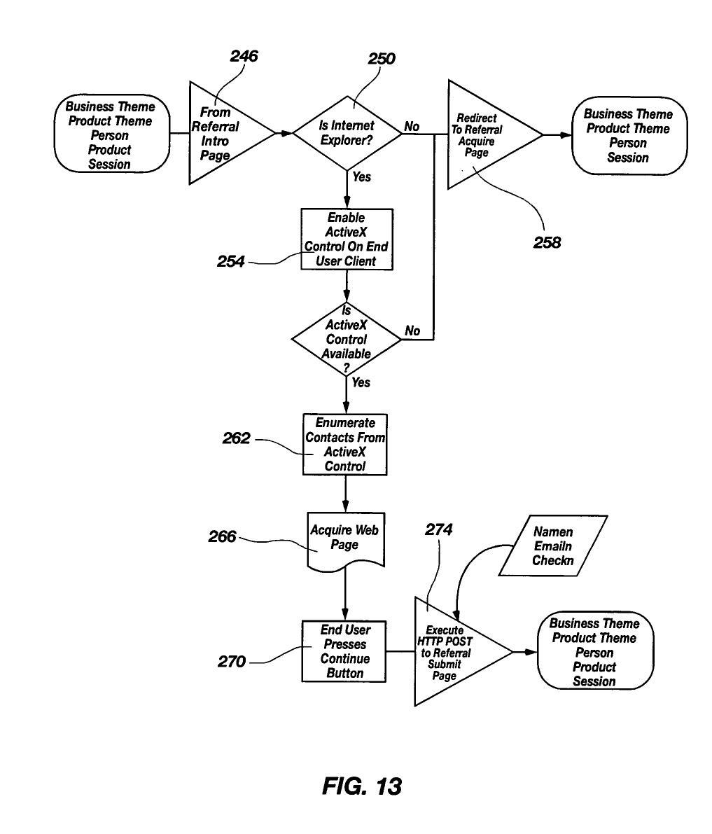

Turning to FIG. 13, additional detail is sown regarding the contact gathering process. 246 indicates the initial referral invitation sent to a user. As stated before, this may be a web page that opens as a person is browsing or purchasing a product, or may be sent as an email to a user. When a user decides to send referrals to persons known to him or her, the referral generating software will typically determine if certain functionality is present and enabled on the computer to facilitate the referral process. This includes verifying if the person is using internet explorer 250 and if ActiveX control is available 254. ActiveX allows the referral generating software to automatically extract the contact information from the user's address books. Alternatively, Java and other programs may be used to extract the contact information and steps 250 and 254 could equally be used to determine if Java, etc. is available. If these capabilities are not available on the computer or are not enabled, the user is directed to a manual referral page 258 where they may manually enter referral information to generate the referrals.

If ActiveX, Java, or the like is available and enabled, the referral generating page automatically extracts the contact information 262, typically including first name, last name, full name, and email address, from data bases on the user's computer, including internet email address books and Microsoft Outlook address books.

An acquire web page 266 then displays the names which have been collected. At this point, the user has the option to select or deselect all names, select or deselect individual names, add new names, and otherwise manage the referral list. The user may also be shown the referral which is to be sent and given an opportunity to change some of the referral text. Certain text fields, such as the product specifications, will not be modifiable by the user, while certain other text fields, such as the endorsement of the product or encouragement for others to use the product, may be modifiable by the user.

When satisfied with the referral, the user will press a continue button 270 to send the referral. At this point, the referral information may be uploaded to the referral server 274. All of the information collected may be uploaded to the server, or the unselected contacts may be deleted from the list prior to uploading to the server to save time during upload. This uploading to the server may be done in the background on the user's computer to minimize the inconvenience to a user.

Once the contact information and referral information have been uploaded to the referral server, the referrals are typically sent as emails to the contacts. The individual emails will not be discarded as spam because they are sent by an individual known to the recipient. Additionally, if multiple emails are being sent to a single internet service provider, such as AOL, the emails will be sent out individually at predetermined intervals so that the service provider does not receive a large number of emails from a single sender at the same time and classify the group of emails as spam.

Additional steps may be added to the referral process to ensure a valid referral. For example, prior to gathering references and sending a referral, the user may be given a survey that asks questions regarding the user's satisfaction with a product, interest in a product, or the like to determine if that person is pleased with a product or service and will send out positive referrals to persons known to him or her. If the persons responds positively to the survey questions, the referral generating page is then opened to begin the referral process. This ensures that only good referrals are sent out, maintaining the integrity of the advertising process.

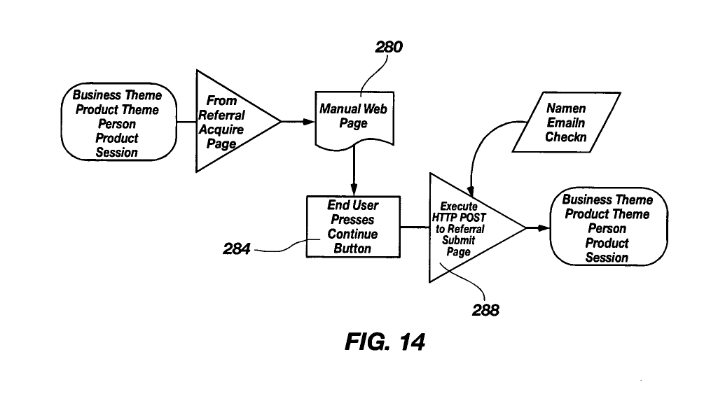

Turning now to FIG. 14, a flow diagram is shown of the manual contact entry, as shown in 258 of FIG. 13. If the user's computer does not have or does not allow Java, ActiveX, or the like to extract contact information, the user is directed to a manual entry page 280, as shown in FIG. At the manual entry page, the user is able to enter contact information and customize a referral. When the user is finished, the will press a continue button 284, which will upload the contact information to the referral server 288 and send the referrals, as described in reference to FIG. 13.

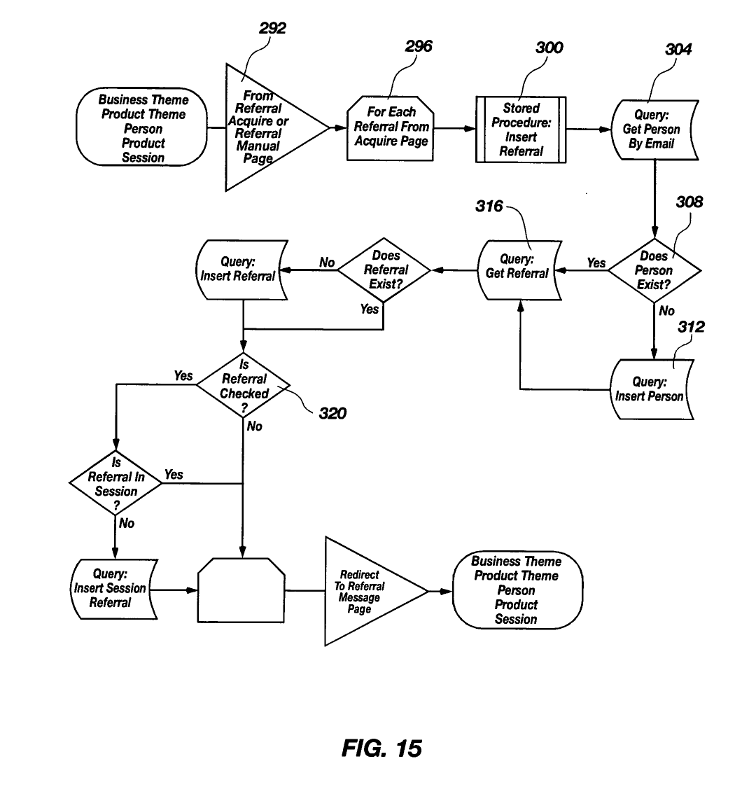

Tunring now to FIG. 15, a flowchart outlining aspects of submitting the referrals to the referral server is shown. The referrals which are submitted by the user 292 are to be saved and processed in the referral server. Each referral 296 must be stored in a database 300. It is desirable to store the new referrals without duplicating information already in the database. The referral server then selects each new referral and uses their email address to determine whether that email address already exists in the database 308. If the person does not yet exist in the database, the referral is inserted into the database 312.

If a referral already exists in the database, the referral server then determines who referred the person 316 to determine if it is a duplicate referral or if a new user referred a person that had been referred by another person previously. If it is a new referral, it is entered into the database.

The referral server may also be configured to determine if a contact which has been sent to the server was checked to receive a referral, or unchecked so as to not receive a referral 320. If a contact was unchecked it is not entered into the database, and all checked contacts are entered into the database. After all referrals are entered into the database, the referrals are sent as previously discussed.

The referral server may also be configured to accommodate for a variety of products, allowing a user to send referrals to their contacts for different products without being identified as a duplicate referral. If a referral is sent to the referral server and the contact is already in the server as having been referred by the user, the server may then check which product was previously referred, and if the new referral is for a different product, the referral is entered into the database.

Similar steps may be taken in managing the business clients and products which are stored in the server. New businesses and products or services may be entered into the referral server to allow referrals to be sent for those products. When a new product is entered into the server, information such as a product title, product description, referral seed email list, and referral messages will be stored in the server, as these are necessary for sending the referrals.

Seed email lists may be used to start a referral process. For example, a company may compile an email list of its current customers and save this as the seed email list in the referral server. Emails are then sent to these customers asking them to refer the product to their friends, starting the referral process as outlined above.

After a referral is sent by a user, a thank you message is typically sent or presented to the user. This may be a simple thank you text saved on the referral server, or each company may create its own thank you page having a more detailed thank you and the referral server can automatically load or otherwise direct the user to the thank you page.

There has thus been disclosed an improved method of viral marketing. It will be appreciated that numerous modifications of the example embodiments described herein may be made without departing from the scope of the appended claims.

1. A marketing method comprising:
providing a message to a customer asking them to refer a product or service to other persons;
generating a message endorsing the product or service to be sent to the other persons;
automatically generating a contact list of persons known to the customer to whom the endorsement will be sent; and
sending the endorsement message to selected persons.

2. The method of claim 1, wherein the message to a customer is sent through email.

3. The method of claim 1, wherein the message endorsing the product is sent to other persons through email.

4. The method of claim 1, wherein an incentive is provided to the customer for sending endorsement messages to other persons.

5. The method of claim 1, wherein an incentive is provided to the other persons to encourage their use of the product.

6. The method of claim 1, wherein the contact list is generated by collecting information from the customer's email address book.

7. The method of claim 1, wherein the method further comprises not sending the message to persons unselected by the customer.

8. A marketing method comprising:
asking a customer to refer a product to other persons;
generating a message endorsing of the product to be sent to the other persons;
generating a contact list of persons known to the customer to whom the endorsement will be sent from the customers' database; and
sending the endorsement message to the persons.

9. The method of claim 8, wherein a web page is used to ask the customer to refer the product to others after the customer downloads or purchases a product from the internet.

10. The method of claim 8, wherein an incentive is offered to the customer to encourage them to send an endorsement to others.

11. The method of claim 8, wherein the endorsement message is generated automatically.

12. The method of claim 8, wherein the contact list is generated automatically.

13. The method of claim 8, wherein the contact list is generated by collecting information from the customer's email address book.

14. The method of claim 8, wherein the endorsement message is automatically sent to the persons on the contact list.

15. A method of advertising comprising:
asking a person to endorse at least one of the group consisting of a good, service, information, a company, a website, and a product to individuals known to the person;
automatically generating a contact list of individuals known to the person to whom the endorsement will be sent; and
sending the endorsement to the individuals.

16. The method according to claim 15, further comprising automatically generating the endorsement.

17. The method according to claim 15, further comprising selecting the contact list from at least one of the group consisting of email address books, instant messaging lists, hand-held organizer databases, and computer databases.
